(19) United States
(12) Patent Application Publication
(10) Pub. No.: US 2026/0336340 A1
(43) Pub. Date: Oct. 29, 2026

(54) ADJUSTABLE BALL MOUNT

(71) Applicant: Harbor Freight Tools USA, Inc., Calabasas, CA (US)

(72) Inventor: Troy L. Freeman, Sweetser, IN (US)

(73) Assignee: Harbor Freight Tools USA, Inc., Calabasas, CA (US)

(21) Appl. No.: 19/660,007

(22) Filed: Apr. 27, 2026

Related U.S. Application Data
(60) Provisional application No. 63/796,027, filed on Apr. 28, 2025.

(51) Int. Cl. B60D 1/46; B60D 1/06

(52) U.S. Cl. CPC B60D 1/46; B60D 1/06

(57) ABSTRACT

An adjustable ball mount is configured to be removably coupled to a hitch receiver of a vehicle. The adjustable ball mount includes a shank, and a ball mount couped to the shank. The ball mount includes a base block, and a base member extending outward from the base block, a trailer ball coupled to an end of the base member opposite the ball mount, a first bumper removably coupled to a first side of the base block, and a second bumper removably coupled to a second side the ball mount. The second side is opposite the first side.

### CROSS-REFERENCE TO RELATED PATENT APPLICATION

This Application claims the benefit of and priority to U.S. Provisional Patent Application No. 63/796,027, filed Apr. 28, 2025, which is incorporated herein by reference in its entirety.

### BACKGROUND

An adjustable ball mount is a piece of equipment used to couple to a hitch receiver of a trailer, or other device, to a vehicle for towing. Some adjustable ball mounts include one or more trailer balls that couple with a portion of the trailer, such as a trailer coupler. The adjustable ball mount is removably coupled to a hitch receiver of the vehicle. The vehicle hitch receiver and/or portions of the adjustable ball mount are sized to receive an attachment portion, such as a trailer ball or trailer coupler. However, once coupled, the trailer ball may rotate or slide which may cause the trailer or trailer ball to hit or contact another portion of the adjustable ball mount or the vehicle hitch receiver, which may wear down parts of the adjustable ball mount and possible damage the adjustable ball mount, the trailer, or the vehicle itself.

### SUMMARY OF THE INVENTION

At least one embodiment relates to an adjustable ball mount is configured to be removably coupled to a hitch receiver of a vehicle. The adjustable ball mount includes a shank, and a ball mount coupled to the shank. The ball mount includes a base block, and a base member extending outward from the base block, a trailer ball coupled to an end of the base member opposite the base block, a first bumper removably coupled to a first side of the ball mount, and a second bumper removably coupled to a second side the ball mount. The second side is opposite the first side.

Another embodiment relates to an adjustable ball mount assembly including a shank comprising a first end and a second end opposite the first end and a bracket coupled to the second end of the shank. The bracket includes a first wall, a second wall, and a back wall. Each of the first wall and the second wall define a plurality of apertures. The hitch assembly also includes an adjustable ball mount configured to be coupled to the bracket between the first wall and the second wall. The adjustable ball mount includes a base including a connecting member positioned on an end of the base opposite the back wall and configured to couple an accessory to the adjustable ball mount, a first bumper removably coupled to a first side of the base and in contact with the second wall, and a second bumper removably coupled to a second side of the base and in contact with the second wall.

Another embodiment relates to an adjustable ball mount assembly including a shank defining a plurality of base apertures, and a bracket. The bracket includes a bracket wall coupled to the shank, a first wall and a second wall extending from the bracket wall and each defining a plurality of apertures. The first wall, the second wall, and the bracket wall define a bracket channel. The hitch assembly also includes an adjustable ball mount configured to be removably coupled to the bracket at least partially within the bracket channel. The adjustable ball mount includes a base block movably positioned at least partially in the bracket channel. The base block defines a plurality of base apertures. The adjustable ball mount includes a base member coupled to the base block. The base member extends substantially perpendicular to the base block. The adjustable ball mount includes at least one ball mount coupled to an end of the base member opposite the base block, a first bumper removably coupled to the adjustable ball mount and in contact with the first wall, and a second bumper removably coupled to the adjustable ball mount and in contact with the second wall. The hitch assembly also includes at least one hitch pin assembly configured to couple the adjustable ball mount to the bracket.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a side perspective view of an adjustable ball mount assembly, according to an exemplary embodiment;

FIG. 2 is another side perspective view of the adjustable ball mount assembly, according to the embodiment of FIG. 1;

FIG. 3 is a perspective view of a shank of the adjustable ball mount assembly, according to the embodiment of FIG. 1;

FIG. 4 is a perspective view of a bracket of the adjustable ball mount assembly, according to the embodiment of FIG. 1; and

FIG. 5 is a perspective view of a ball mount of the adjustable ball mount assembly, according to the embodiment of FIG. 1.

### DETAILED DESCRIPTION

Before turning to the figures, which illustrate certain exemplary embodiments in detail, it should be understood that the present application is not limited to the details or methodology set forth in the description or illustrated in the figures. It should also be understood that the terminology is for the purpose of description only and should not be regarded as limiting.

The present disclosure teaches an adjustable ball mount including bumpers to minimize movement of the trailer balls relative to the shank of the adjustable ball mount to reduce wear on the adjustable ball mount. Additionally, the bumpers associated with the adjustable ball mount eliminate any noise during periods of use between the bumpers, the base, and the brackets at the joint in which the bumpers are located. The placement of the bumpers provides a user with easier access to the bumpers to replace or perform routine maintenance on the bumpers. Further, incorporating more than one bumper associated with the adjustable ball mount provides a user with a trailer hitch assembly having more than one point of failure.

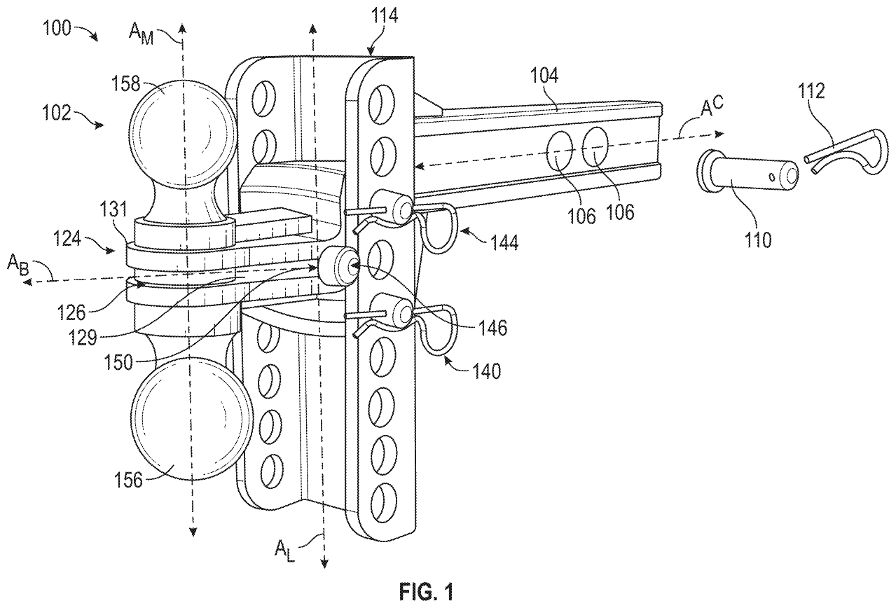

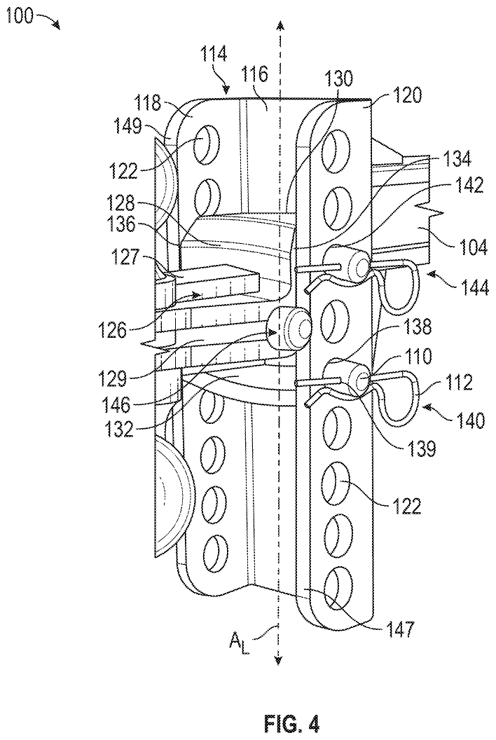

FIG. 1-5 illustrate an adjustable ball mount assembly 100 according to one embodiment. The adjustable ball mount assembly 100 includes a ball mount 102 selectively coupled (e.g., removably coupled, adjustably coupled, etc.) to a shank 104. The ball mount 102 includes a first trailer ball 156 and a second trailer ball 158 configured to receive a trailer (e.g., a coupler of a trailer, a trailer accessory, a vehicle accessory, etc.) to selectively couple the trailer to a vehicle via the adjustable ball mount assembly 100.

Referring now to FIG. 1-3, the adjustable ball mount assembly 100 includes the shank 104 (e.g., an elongated member, a bar, a beam, a tube, etc.). The shank 104 is configured to be received by a hitch receiver coupled to, or positioned on, the vehicle. For example, the shank 104 may be inserted into (e.g., slid into, etc.) a tube member of the hitch receiver of the vehicle.

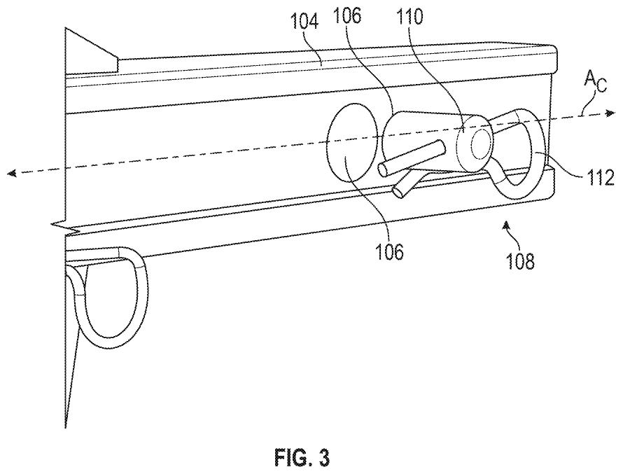

The shank 104 includes a plurality of apertures 106. The plurality of apertures 106 extend through the shank 104 and are configured to receive a pin and clip assembly 108. The pin and clip assembly 108 includes a pin 110 and a clip 112 (shown in FIG. 3). For example, when the shank 104 is inserted into the hitch receiver of the vehicle, at least one of the apertures 106 is aligned with a hitch aperture of the hitch receiver of the vehicle. The pin 110 is inserted through each of the hitch apertures and at least one of the apertures 106 and the clip 112 is positioned through a pin aperture of the pin 110 to secure the shank 104 to the hitch receiver of the vehicle.

Referring now to FIGS. 1, 2, and 4, the adjustable ball mount assembly 100 also includes a bracket 114. The bracket 114 is coupled to the shank 104 at an end opposite the apertures 106. The bracket 114 may be welded to, bolted to, or otherwise coupled to the shank 104. In some embodiments, the bracket 114 is integral with the shank 104. The bracket 114 is configured to couple, or secure, a coupling mechanism (e.g., a ball mount, a clip, a hook, etc.) to the shank 104.

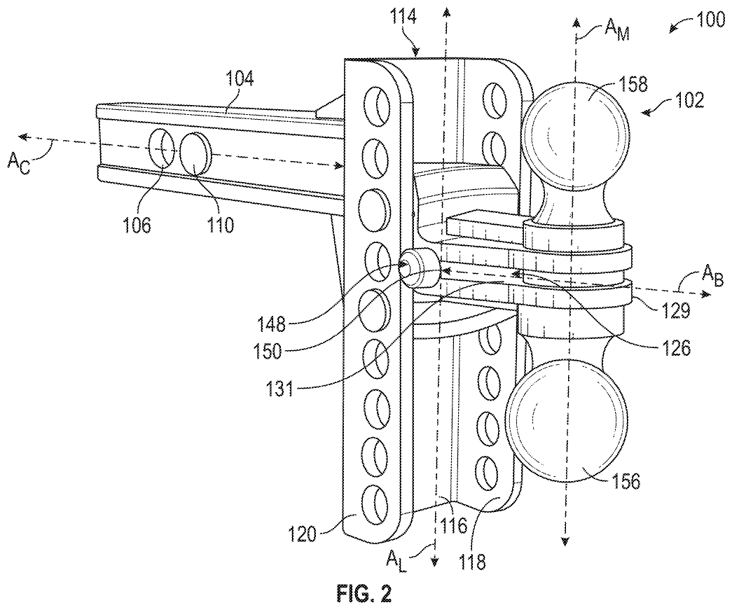

The bracket 114 includes a base wall 116, a first wall 118, and a second wall 120. The base wall 116 is coupled to the shank 104. The base wall 116 defines a longitudinal axis A_{L}. The bracket longitudinal axis A_{L} extends substantially perpendicularly to a central axis A_{C} of the shank 104, see FIG. 2. The base wall 116, the first wall 118, and the second wall 120 define a bracket cavity. The bracket cavity is configured to receive the ball mount 102.

The first wall 118 is coupled to or extends from a first longitudinal edge of the base wall 116. In some embodiments, the first wall 118 extends perpendicular to the base wall 116. The second wall 120 is coupled to or extends from a second longitudinal edge of the base wall 116 opposite the first longitudinal edge. In some embodiments, the second wall 120 extends perpendicular to the base wall 116. The base wall 116, the first wall 118, and the second wall 120 thus define a C-shaped or U-shaped bracket cavity extending along the bracket longitudinal axis A_{L}. In alternative embodiments, the first wall 118 and the second wall 120 may extend from the base wall 116 in which the first wall 118 and/or the second wall 120 are not perpendicular to each other (e.g., the first wall 118 and the second wall 120 extend at an angle less than 90 degrees or an angle greater than 90 degrees, etc.).

Each of the first wall 118 and the second wall 120 define a plurality of bracket apertures 122. The plurality of apertures 122 are configured to receive a first pin clip assembly 140 and a second pin clip assembly 144 to secure the ball mount 102 to the bracket 114. In some embodiments, the plurality of apertures 122 in the first wall 118 and the second wall 120 are aligned, such that a straight line may pass through the plurality of apertures 122 in the first wall 118 and through the plurality of apertures 122 in the second wall 120. In other embodiments, the plurality of apertures 122 in one of the first wall 118 or the second wall 120 are offset from the plurality of apertures 122 in the other of the first wall 118 or the second wall 120. The plurality of apertures 122 are shown to be circular, but the plurality of apertures 122 may be another shape such as triangular, hexagonal, square, etc. As shown, each aperture 122 in the plurality of apertures 122 is equally spaced from another aperture 122 in the plurality of apertures 122. In some embodiments however, the plurality of apertures 122 may be unevenly spaced, such that a distance between two apertures 122 in the plurality of apertures 122 may be larger or smaller than a second distance between other apertures 122 in the plurality of apertures 122.

Referring now to FIGS. 1, 2, and 5, the adjustable ball mount assembly 100 includes the ball mount 102 with the first trailer ball 156 and the second trailer ball 158. The ball mount 102 is positioned to slide within the bracket cavity of the bracket 114 defined by the base wall 116, the first wall 118, and the second wall 120. When in the desired position, the ball mount 102 may be releasably coupled to the bracket 114 via the first pin clip assembly 140 and the second pin clip assembly 144. The ball mount 102 is configured to removably couple the trailer to the hitch receiver of the vehicle. For example, the ball mount 102 is configured to receive a portion of the trailer such as a tongue of the trailer over at least one of the first trailer ball 156 or the second trailer ball 158.

The ball mount 102 includes a base 126. When the ball mount 102 is coupled to the bracket 114, the base 126 is positioned adjacent to the bracket 114. For example, the base 126 is in contact with at least the base wall 116 of the bracket 114. The base 126 includes a base member 127 and a base block 128. The base block 128 is positioned on an end of the base 126 positioned adjacent to the bracket 114, and the base member 127 extends outward from the base block 128. According to this embodiment, the base member 127 and the base block 128 are integrally formed (e.g., cast, etc.). In other embodiments, the base member 127 and the base block 128 are formed separately and coupled to one another (e.g., via sintering or a fastener). The base block 128 is adjacent to the bracket 114. Portions of the base block 128 may be in contact with the bracket 114. The base block 128 is substantially rectangular in shape. The base block 128 is also movable within the bracket cavity of the bracket 114. The base 126 defines a base longitudinal axis A_{B}. The base longitudinal axis A_{B} is substantially perpendicular to the bracket longitudinal axis A_{L}. In some embodiments, the base longitudinal axis A_{B} is parallel to, and in some further embodiments offset (e.g., vertically offset, etc.) from the central axis A_{C} of the shank 104.

The base block 128 includes a back base side 130, a front base side 132, a first base side 134, and a second base side 136. The back base side 130 is adjacent to and may be in contact with the base wall 116 of the bracket 114. The base member 127 is coupled to, or integrally formed with, or extends from, the front base side 132 of the base block 128. The front base side 132 is positioned opposite the back base side 130 (e.g., the back base side 130 is positioned on a top side and the front base side 132 is positioned on a bottom side opposite the top side, etc.). The first base side 134 is positioned opposite the second base side 136 (e.g., the first base side 134 is positioned on a first lateral side and the second base side 136 is positioned on a second lateral side opposite the first lateral side, etc.). The base block 128 defines a first base aperture 138. The first base aperture 138 extends from the first base side 134 through the base block 128 to the second base side 136. For example, each of the first base side 134 and the second base side 136 define openings of the first base aperture 138.

The first base aperture 138 is configured to receive the first pin clip assembly 140. For example, the pin 110 of the first pin clip assembly 140 is positioned (e.g., threaded, etc.) through a first one of the plurality of bracket apertures 122 on the second wall 120, the first base aperture 138 on the first base side 134 through to the second base side 136 and through another one of the plurality of bracket apertures 122 located on the first wall 118. Clips 112 may be inserted into the respective pin apertures located in the pins 110 located in the first wall 118 and the second wall 120.

According to this embodiment, the base block 128 defines a second base aperture 142. The second base aperture 142 extends from the first base side 134 through the base block 128 to the second base side 136. The second base aperture 142 is configured to receive a second pin clip assembly 144.

The base member 127 includes a first member side 129 and a second member side 131. The first member side 129 extends from the first base side 134. The second member side 131 extends from the second base side 136. The first member side 129 is continuous with the second member side 131 on a distal end of the base member 127 (e.g., an end opposite the base block 128, etc.).

As shown in FIGS. 1, 2, and 4 the bracket 114 receives the base 126 (e.g., receives the base block 128 of the base 126, etc.) of the ball mount 102 such that the back base side 130 is adjacent to the base wall 116 of the bracket 114. The first wall 118 and the second wall 120 extend away from the base wall 116 (e.g., substantially perpendicular to, outward from, etc.) and comprise a length greater than a depth of the first base side 134 and the second base side 136. For example, the first wall 118 and the second wall 120 extend past the edge of the front base side 132 and each of the first base side 134 and the second base side 136. For example, the first wall 118 and the second wall 120 of the bracket 114 have a greater length than each of the first base side 134 and the second base side 136 or protrude outwards from the base wall 116 a distance greater than the first base side 134 and the second base side 136.

When the base 126 is positioned in the bracket 114 (e.g., in the bracket channel, the bracket cavity, etc.), the first base aperture 138 and the second base aperture 142 are each aligned with one of the plurality of bracket apertures 122. A user then positions, or places, a securing mechanism, such as a pin and clamp assembly (e.g., the first pin clip assembly 140 and the second pin clip assembly 144) through a first one of the plurality of bracket apertures 122 in at least one of the first wall 118 or the second wall 120 and then through a second of the plurality of apertures 122 in the other of the at least one of the first wall 118 or the second wall 120 and each of the first base aperture 138 and the second base aperture 142, securing the ball mount 102 to the bracket 114. For example, the user inserts the pin 110 through one of the apertures 122 in the second wall 120, such that the pin 110 passes through the first base aperture 138 of the base 126 and through another aperture 122 in the second wall 120. The base 126 is configured to be secured to the bracket 114 by inserting the clip through the pin aperture 139 located on the pin 110, wherein the pin 110 passes through the second wall 120, the first base aperture 138, and the first wall 118. Another one of the pins 110 (e.g., a second pin 110) may be used to secure the base 126 to the bracket 114. The user may insert another one of the pins 110 through another one of the apertures 122 in the second wall 120, the pin 110 passes through the second base aperture 142 of the base 126 and through another one of the apertures 122 extending through the first wall 118. The base 126 is further secured to the bracket 114 by inserting another one of the clips 112 through the pin aperture located on the pin 110 passing through the second wall 120, the second base aperture 142, and the first wall 118.

The ball mount 102 further includes a first bumper 146 and a second bumper 148. The first bumper 146 is positioned on the first member side 129 and the second bumper 148 is positioned on the second member side 131. In other embodiments the first bumper 146 is positioned on the first base side 134 of the base block 128 and the second bumper 148 is positioned on the second base side 136 of the base block 128. In another embodiment, the first bumper 146 is positioned on the first base side 134 of the base block 128 and the second bumper 148 is positioned on the second base side 136 of the first base aperture 138 and each of the first bumper 146 and the second bumper 148 are offset (e.g., vertically offset, etc.) from the base longitudinal axis A_{B}. For example, the first bumper 146 and the second bumper 148 may be positioned vertically above the base longitudinal axis A_{B.}

According to this embodiment, the second bumper 148 is aligned with (e.g., axially aligned, etc.), or positioned, opposite, first bumper 146 (e.g., along a transverse axis of the base member 127, along an axis perpendicular to the base longitudinal axis A_{B}, etc.). The first bumper 146 is adjacent to and may be in contact with an outer edge 147 or face of the first wall 118 and the second bumper 148 is adjacent to and may be in contact with an outer edge 149 or face of the second wall 120 of the bracket 114. For example, the first bumper 146 and the second bumper 148 may roll, rotate, or slide along each of the outer edge 147 and the outer edge 149, respectively, when moving the ball mount 102 along the bracket longitudinal axis A_{L} (e.g., up, and down along the bracket longitudinal axis A_{L}). The positioning of each of the first bumper 146 and the second bumper 148 on the sides of the base member 127 may facilitate rolling or rotating of the first bumper 146 and the second bumper 148 along the outer edge 147 and the outer edge 149, reducing friction (e.g., as opposed to sliding, etc.) and thus reducing wear on each of the first bumper 146 and the second bumper 148 as opposed to being positioned on the bracket 114. For example, the first bumper 146 and the second bumper 148 may be comprised of a low friction material (e.g., acetal or Delrin, polyurethane, polyethylene, or some other material) to facilitate the rolling or rotating of the first bumper 146 and the second bumper 148 along each of the outer edge 147 and the outer edge 149 respectively to reduce wear on the first bumper 146 and the second bumper 148. In other embodiments, the first bumper 146 and the second bumper 148 may be comprised of a material that grips the outer edge 147 and the outer edge 149 and reduces rotation of the first bumper 146 and the second bumper 148 to reduce rattling or movement of the base member 127 relative to the bracket 114 (e.g., an elastomeric or rubber material, such as nitrile rubber, butyl rubber, or some other material).

As shown in FIGS. 1 and 2, the first bumper 146 and the second bumper 148 are offset (e.g., vertically, etc.) from the central axis A_{C}. The first bumper 146 and the second bumper 148 are positioned on or aligned with the base longitudinal axis A_{B}. For example, the first bumper 146 and the second bumper 148 are positioned at a center point (e.g., substantially center, etc.) between the first pin clip assembly 140 and the second pin clip assembly 144, for example between the first trailer ball 156 and the second trailer ball 158 on the base 126, and horizontally offset (e.g., offset a distance along the base longitudinal axis A_{B}, etc.) from a trailer ball axis A_{M} that extends through each of the first trailer ball156 and the second trailer ball 158. In other embodiments, the first bumper 146 and the second bumper 148 are positioned substantially aligned or along the central axis A_{C}.

Further the positioning of each of the first bumper 146 and the second bumper 148 on the sides of the base member 127 allows the user to install the second bumper 148 before installing the first bumper 146. Further, the user can install the first bumper 146 before the second bumper 148 (e.g., they are interchangeable, can be installed in either order, etc.).

The first bumper 146 and the second bumper 148 are configured to stabilize the ball mount 102 within the bracket 114 such that movement of the ball mount 102 within the bracket 114 (e.g., in the bracket cavity, etc.) is minimized and/or eliminated. For example, the ball mount 102 may shake or slide slightly within the bracket 114 causing a rattling noise. During operation, the ball mount 102 may also attempt to rotate around the axis A_{M}. In response the first bumper 146 and the second bumper 148 are configured to selectively engage with and/or apply pressure to each of the outer edge 147 and the outer edge 149 of the second wall 120 and the first wall 118, respectively, minimizing movement, such as rotation and sliding, vibration, and noise of the ball mount 102 within and/or relative to the bracket 114 when the ball mount 102 is coupled to the bracket 114.

According to this embodiment, each of the first bumper 146 and the second bumper 148 are removably coupled to the base member 127 of the base 126. For example, the base member 127 defines at least one bumper aperture 150. The at least one bumper aperture 150 comprises a threading. As such, each of the first bumper 146 and the second bumper 148 are threadedly coupled to the base member 127 via the bumper aperture 150. In some embodiments, the threading is omitted. According to some embodiments, the bumper aperture 150 is a single aperture, or cavity defined through the base member 127. For example, the bumper aperture 150 is defined through the base member 127 from the first member side 129 to the second member side 131. In other embodiments, the base member 127 defines two bumper apertures 150. For example, the base member 127 defines a first bumper aperture 150 on the first member side 129 configured to receive the first bumper 146 and a second bumper aperture 150 on the second member side 131 configured to receive the second bumper 148.

The positioning of the first bumper 146 and the second bumper 148 on the first member side 129 and the second member side 131, respectively, facilitate contact of the first bumper 146 with the outer edge 147 and the second bumper 148 with the outer edge 149. Further, this positioning facilitates the replacement of one, or both of, the first bumper 146 and the second bumper 148 while the ball mount 102 is attached or coupled to the bracket 114. For example, the user can visually inspect each of the first bumper 146 and the second bumper 148 while the ball mount 102 is coupled to the bracket 114 (e.g., the first pin clip assembly 140 and the second pin clip assembly 144 are positioned through each of the bracket 114 and the base block 128 coupling the ball mount 102 to the bracket 114, etc.). The user can then remove one of, or both of, the first bumper 146 and the second bumper 148 while the ball mount 102 is coupled to the bracket 114 (e.g., without uncoupling the ball mount 102, etc.) and replace one of, or both of, the first bumper 146 and the second bumper 148 with new bumpers. This facilitates a faster and easier replacement of the first bumper 146 and the second bumper 148 with new bumpers.

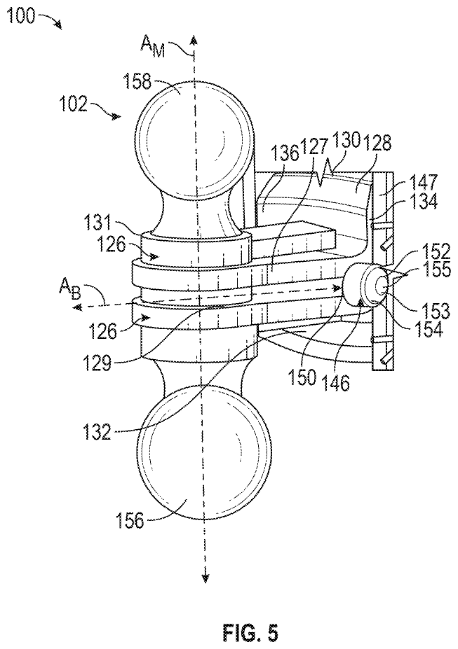

Referring now to FIG. 5, a deformable portion 154 of each of the first bumper 146 and the second bumper 148 are substantially circular or ring shaped. As such, in some embodiments the deformable portion 154 can roll along each of the outer edge 147 and the outer edge 149. For example, as the base block 128 moves vertically along the longitudinal axis A_{L}, the deformable portion 154 can rotate or slide along the outer edge 147 and the outer edge 149 reducing collisions or movement between the base 126 and the bracket 114 and thus reducing noise and wear and tear on the adjustable ball mount assembly 100. In other examples, the deformable portion 154 can be some other shape (e.g., rectangular, oval) and can have a smooth or roughened (e.g., textured) surface.

The positioning of the first bumper 146 and the second bumper 148 on the sides of the base block 128 is further advantageous in the event one of the deformable portions 154 is displaced during use. For example, because the first bumper 146 and the second bumper 148 are positioned on the sides of the base block 128, the distance between a back side of the base block 128 and the base wall 116 of the bracket 114 is constant (e.g., a gap between the base block 128 and the base wall 116 is constant, the back side of the base block 128 is in constant contact with the base wall 116, etc.) since the first bumper 146 and the second bumper 148 are not positioned between the base block 128 of the ball mount 102 and the bracket 114. As such the first bumper 146 and the second bumper 148 minimize twisting or rattling between the ball mount 102 and the bracket 114. In the event the deformable portion 154 is displaced, a user can provide a new (e.g., replacement) deformable portion 154 without removing the ball mount 102 from the bracket 114.

The at least one bumper aperture 150 is positioned on the base 126. For example, the at least one bumper aperture 150 is positioned laterally offset, along a longitudinal axis, such as the base longitudinal axis A_{B}, from the first base aperture 138 and the second base aperture 142. The at least one bumper aperture 150 is also positioned between each of the first base aperture 138 and the second base aperture 142. For example, the at least one bumper aperture 150 is both vertically and horizontally offset from each of the first base aperture 138 and the second base aperture 142.

Each of the first bumper 146 and the second bumper 148 include a rod 152. In some embodiments, the rod 152 comprises a threaded portion configured to engage with threading of the at least one bumper aperture 150. In other examples, the rod 152 is otherwise coupled to the bumper aperture 150 (e.g., via retaining ring, welding, adhesive, or some other coupling method). The rod 152 may be comprised of a metal, such as steel. Each of the first bumper 146 and the second bumper 148 are individually, and selectively coupled, or threaded into the at least one bumper aperture 150. As such, each of the first bumper 146 and the second bumper 148 can be selectively removed, and/or replaced. For example, if one of the first bumper 146 or the second bumper 148 are damaged, worn down, or misplaced, the user may replace just one of the first bumper 146 or the second bumper 148 and leave the functional bumper (e.g., the first bumper 146 or the second bumper 148, etc.) threaded into the rod 152 of the base block 128. For example, the first bumper 146 and the second bumper 148 are positioned such that either one of the first bumper 146 and the second bumper 148 can be accessed or removed while the ball mount 102 is coupled to the bracket 114. As such, the user may exchange one of the first bumper 146 or the second bumper 148 without disconnecting the ball mount 102 from the bracket 114.

As shown in at least FIGS. 1, 2, and 5, the rod 152 includes a rod head 153. The rod head 153 defines an indent or recess 155 configured to received or selectively engage with a tool, such as an Allen wrench. For example, an Allen wrench engages with the recess 155 to apply torque to the rod 152 to tighten or loosen the rod 152 from the base block 128 for securing or removing the rod 152 from the base 126 of the ball mount 102.

Each of the first bumper 146 and the second bumper 148 also includes a bumper portion such as the deformable portion 154. According to this embodiment, the deformable portion 154 is comprised of a rubber material or elastomeric material, such as nitrile rubber, natural rubber, butyl rubber, or some other rubber, polymeric, or elastomeric material. In other embodiments, the deformable portion 154 is comprised of a different material such as wood or plastic. The deformable portion 154 is substantially circular in shape. For example, the deformable portion 154 is substantially ring shaped, and surround a portion of the rod 152. The deformable portion 154 is detachable, or removable, from the rod 152. For example, in some embodiments, the deformable portion 154 is removable from the rod 152, such that the rod 152 is reusable and a new deformable portion 154 can be placed on the same rod 152. While shown as circular, the deformable portion may be another shape (e.g., triangular, square, pentagonal, etc.)

The deformable portion 154 of each of the first bumper 146 and the second bumper 148 are visible to the user while the ball mount 102 is coupled to the bracket 114. As such, each of the deformable portions 154 of the first bumper 146 and the second bumper 148 can be removed and/or replaced while the ball mount 102 is positioned in the bracket 114. For example, the user may visually inspect each of the first bumper 146 and the second bumper 148 (e.g., view the sides of the adjustable ball mount assembly 100 or view from the front along the center axis A_{C}, etc.) while the ball mount 102 is coupled to the bracket 114, and determine that one of both of the deformable portions 154 of the first bumper 146 and the second bumper 148 need to be replaced. The user can then remove one of the first bumper 146 or the second bumper 148, while the ball mount 102 remains stationary and coupled to the bracket 114, and thread or slide a new deformable portion 154 onto the rod 152 of either the first bumper 146 or the second bumper 148. The user may remove both of the first bumper 146 and the second bumper 148 and replace each of the deformable portions 154 with new deformable portions 154 or replace the deformable portion 154 on one of the first bumper 146 or the second bumper 148. This provides the technical benefit of allowing a user to inspect and replace portions of the adjustable ball mount assembly 100 without disassembling or removing parts of the adjustable ball mount assembly 100. Accordingly, parts of the adjustable ball mount assembly 100 can be easily replaced (e.g., roadside, etc.) without disassembly thus reducing the likelihood of misplacing a component.

In some embodiments, the deformable portion 154 is flexible or stretchable. For example, the user can flex or stretch the deformable portion 154 around the rod head 153 and onto the rod 152 between the base member 127 and the rod head 153. As such, the deformable portions 154 can be removed and replaced without removal of the rod 152 of either the first bumper 146 or the second bumper 148.

The deformable portion 154 may deform or conform to the shape of the bracket 114. For example, the deformable portion 154 is configured to deform around the edges of the first wall 118 and the second wall 120 minimizing movement of the base block 128 within the bracket 114. In some embodiments the deformable portion 154 is in constant or near constant contact with the bracket 114. In other embodiments, the deformable portion comes into contact with the bracket 114 based on movement of one of the bracket 114 or the ball mount 102 relative to the other of the bracket 114 or the ball mount 102.

The ball mount 102 includes the first trailer ball 156 and the second trailer ball 158. Each of the first trailer ball 156 and the second trailer ball 158 are coupled to the base member 127 of the base 126. Each of the first trailer ball 156 and the second trailer ball 158 are positioned on an end of the ball mount 102 opposite (e.g., positioned a distance away from, etc.) the bracket 114. The first trailer ball 156 is positioned on a first side (e.g., a first face, etc.) of the base member 127 of the base 126, and the second trailer ball 158 is positioned on a second side (e.g., a second face, etc.) of the base member 127 of the base 126. The second trailer ball 158 and the first trailer ball 156 are aligned (e.g., positioned on, etc.) with the trailer ball axis A_{M} The first trailer ball 156 is larger than the second trailer ball 158. For example, the first trailer ball 156 has a larger diameter than the second trailer ball 158. In other examples, the ball mount 102 includes only one trailer ball or greater than two trailer balls (e.g., 3 or 4 trailer balls).

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

What is claimed is:

1. An adjustable ball mount configured to be removably coupled to a hitch receiver of a vehicle, the adjustable ball mount comprising:
a shank; and
a ball mount coupled to the shank, the ball mount comprising:
a base block;
a base member extending outward from the base block;
a trailer ball coupled to an end of the base member opposite the base block;
a first bumper removably coupled to a first side of the ball mount; and
a second bumper removably coupled to a second side the ball mount, the second side opposite the first side.

2. The adjustable ball mount of claim 1, wherein the first bumper and the second bumper are aligned on a transverse axis of the ball mount.

3. The adjustable ball mount of claim 1, wherein each of the first bumper and the second bumper comprise a deformable portion configured to contact each a first wall and a second wall of a bracket coupled to the hitch receiver of the vehicle.

4. The adjustable ball mount of claim 3, wherein each of the first bumper and the second bumper comprise a rod removably coupled with an aperture of the ball mount.

5. The adjustable ball mount of claim 4, wherein the deformable portion is positioned around the rod.

6. The adjustable ball mount of claim 4, wherein the rod comprises a rod head defining a recess configured to engage with a tool.

7. The adjustable ball mount of claim 1, wherein the base block defines a first base aperture and a second base aperture, each of the first base aperture and the second base aperture are configured to receive a pin.

8. The adjustable ball mount of claim 7, wherein the first base aperture and the second base aperture are positioned along a vertical axis and each of the first bumper and the second bumper are positioned on a horizontal axis offset from the vertical axis, and wherein the horizontal axis is vertically between the first base aperture and the second base aperture.

9. The adjustable ball mount of claim 1, wherein the ball mount comprises a first ball mount, and the ball mount further comprises a second ball mount coupled to the base member.

10. The adjustable ball mount of claim 9, wherein the first ball mount is coupled to a first side of the base member and extends in a first direction and the second ball mount is coupled to a second side of the base member and extends in a second direction.

11. The adjustable ball mount of claim 10, wherein the first ball mount and the second ball mount are aligned on a first axis.

12. The adjustable ball mount of claim 1, further comprising:
a bracket including a bracket wall coupled to the shank and a plurality of walls extending from the bracket wall,
wherein the first bumper and the second bumper are configured to contact at least one of the plurality of walls of the bracket.

13. An adjustable ball mount assembly comprising:
a shank comprising a first end and a second end opposite the first end;
a bracket coupled to the second end of the shank, the bracket comprising a first wall, a second wall, and a back wall, each of the first wall and the second wall defining a plurality of apertures; and
an adjustable ball mount configured to be coupled to the bracket between the first wall and the second wall, the adjustable ball mount comprising:
a base having a connecting member positioned on an end of the base opposite the back wall and configured to couple an accessory to the adjustable ball mount,
a first bumper removably coupled to a first side of the base and in contact with the first wall, and
a second bumper removably coupled to a second side of the base and in contact with the second wall.

14. The adjustable ball mount assembly of claim 13, wherein the first bumper and the second bumper are aligned on a transverse axis of the base.

15. The adjustable ball mount assembly of claim 13, wherein each of the first bumper and the second bumper comprise a deformable portion configured to contact the first wall or the second wall, respectively.

16. The adjustable ball mount assembly of claim 15, wherein each of the first bumper and the second bumper comprise a rod removably coupled with an aperture of the adjustable ball mount.

17. The adjustable ball mount assembly of claim 16, wherein the deformable portion is positioned around the rod.

18. The adjustable ball mount assembly of claim 13, wherein the base defines a first base aperture and a second base aperture, each of the first base aperture and the second base aperture are configured to receive a pin.

19. The adjustable ball mount assembly of claim 18, wherein the first base aperture and the second base aperture are positioned along a vertical axis and each of the first bumper and the second bumper are positioned on a horizontal axis offset from the vertical axis, and wherein the horizontal axis is vertically between the first base aperture and the second base aperture.

20. An adjustable ball mount assembly comprising:
a shank comprising a plurality of base apertures;
a bracket comprising:
a bracket wall coupled to the shank, and
a first wall and a second wall extending from the bracket wall and each defining a plurality of apertures, the first wall, the second wall, and the bracket wall defining a bracket channel;
an adjustable ball mount configured to be removably coupled to the bracket at least partially within the bracket channel, the adjustable ball mount comprising:
a base block movably positioned at least partially in the bracket channel, the base block defining a plurality of base apertures,
a base member coupled to the base block, the base member extending outward from the base block,
at least one ball mount coupled to an end of the base member opposite the base block,
a first bumper removably coupled to the adjustable ball mount and in contact the first wall, and
a second bumper removably coupled to the adjustable ball mount and in contact with the second wall; and
at least one pin assembly configured to removably couple the adjustable ball mount to the bracket.
